(19) United States
(12) Patent Application Publication
(10) Pub. No.: US 2024/0362052 A1
(43) Pub. Date: Oct. 31, 2024

(54) OPTIMAL MULTI-INSTANCE GPU (MIG) AWARE PLACEMENT OF CLIENTS

(71) Applicant: VMware LLC, Palo Alto, CA (US)

(72) Inventors: Uday Pundalik Kurkure, Los Altos Hills, CA (US); Lan Vu, Palo Alto, CA (US); Hari Sivaraman, Livermore, CA (US)

(21) Appl. No.: 18/308,379

(22) Filed: Apr. 27, 2023

(51) Int. Cl. G06F 9/455; G06T 1/20

(52) U.S. Cl. CPC G06F 9/45558; G06T 1/20; G06F 2009/4557; G06F 2009/45595

(57) ABSTRACT

In one set of embodiments, a computer system can receive a plurality of requests for placing a plurality of clients on a plurality of graphics processing units (GPUs), where each request includes a profile specifying a number of GPU compute slices and a number of GPU memory slices requested by a corresponding client. The computer system can further formulate an integer linear programming (ILP) problem based on the requests and a maximum number of GPU compute and memory slices supported by each GPU. The computer system can then generate a solution for the ILP problem and place the plurality of clients on the plurality of GPUs in accordance with the solution.

### BACKGROUND

Unless otherwise indicated, the subject matter described in this section should not be construed as prior art to the claims of the present application and is not admitted as being prior art by inclusion in this section.

Multi-instance GPU (MIG) is a technology supported by recent graphics processing units (GPUs) that allows multiple clients (e.g., virtual machines (VMs), containers, etc.) to concurrently share use of a single GPU. MIG involves statically partitioning the GPU's compute and memory resources into a number of separate instances, each of which is dedicated for use by a single client. This is different from traditional time-sliced GPU sharing (also known as virtual GPU sharing), which multiplexes client access to the GPU's entire compute capability via time slicing.

There are several techniques for optimizing the placement of clients on a fleet of GPUs under the virtual GPU sharing model. However, given the differences between MIG and virtual GPU sharing, new techniques are needed for optimally placing MIG-enabled clients.

### BRIEF DESCRIPTION OF THE DRAWINGS

FIG. 1 depicts an example operating environment according to certain embodiments.

FIG. 2 depicts a GPU that is partitioned into a number of MIG instances.

FIG. 3 depicts a flowchart for implementing a MIG-aware placement algorithm according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

Embodiments of the present disclosure are directed to techniques for optimally placing clients on GPUs under the MIG model. As used herein, the phrase “placing a client on a GPU” refers to the act of allocating portions of the resources of the GPU for use by that client, typically in accordance with the client's requirements. Once placed in this manner, the client can consume the GPU resources allocated to it over the course of its execution.

### 1. Example Operating Environment and Solution Overview

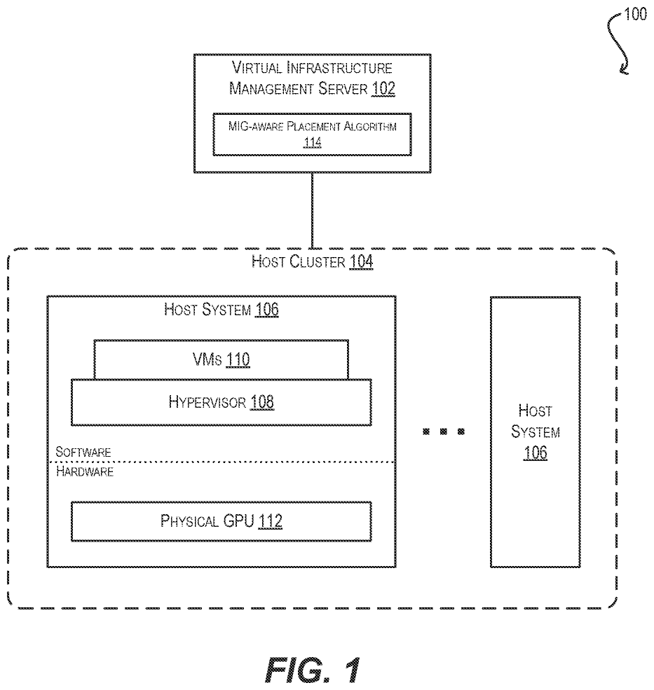

FIG. 1 depicts an example operating environment 100 in which the techniques of the present disclosure may be implemented. As shown, environment 100 is a virtual infrastructure deployment that comprises a virtual infrastructure management (VIM) server 102 communicatively coupled with a host cluster 104. For example, environment 100 may be a cloud deployment of a public cloud provider or an on-premises deployment of an organization/enterprise.

VIM server 102 is a computer system or group of computer systems that is responsible for provisioning, configuring, and monitoring the entities in host cluster 104. In various embodiments, VIM server 102 may run an instance of VMware's vCenter Server or any other similar virtual infrastructure management software.

Host cluster 104 comprises a plurality of host systems 106, each running in software a hypervisor 108 that provides an execution environment for one or more VMs 110. As known in the art, a VM is a virtual representation of a physical computer system with its own virtual CPU(s), virtual storage, virtual GPU(s), etc. Each host system 106 also includes hardware components that are provisioned for use by VMs 110 via hypervisor 108. These hardware components include, among other things, a physical GPU 112. Although not shown in FIG. 1, GPU 112 comprises a set of compute resources (e.g., processing cores, copy engines, hardware encoders/decoders, etc.) and a set of memory resources (e.g., video RAM (VRAM), caches, memory controllers, etc.). For example, the Nvidia Ampere A100 GPU includes 6192 processing cores and 40 gigabytes (GB) of VRAM.

For the purposes of this disclosure, it is assumed that the GPUs of host cluster 104 support MIG, which is a relatively new technology that allows the compute and memory resources of a GPU to be statically partitioned into multiple instances (referred to as MIG instances). Each of these MIG instances can be assigned/allocated to a different client (such as. e.g., one of VMs 110), thereby providing the client with an isolated partition of the GPU for running its GPU workloads.

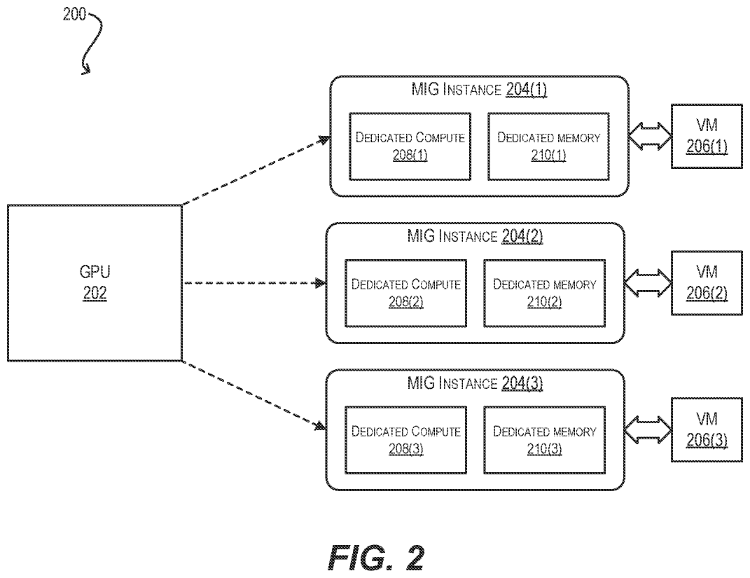

By way of example, FIG. 2 depicts a scenario 200 in which a GPU 202 is partitioned into three MIG instances 204 (1)-(3). These MIG instances are in turn assigned to VMs 206 (1)-(3) respectively, and thus these VMs are said to be “placed” on GPU 202. Each MIG instance 204 includes a separate execution path through GPU 202 that includes a dedicated portion of GPU 202's compute resources (reference numeral 208) and a dedicated portion of GPU 202's memory resources (reference numeral 210). This advantageously ensures that the GPU workload of each VM 206 runs with predictable quality of service (e.g., throughput, latency, etc.) and prevents one VM from impacting the work or scheduling of another.

A GPU that supports MIG is composed of a number of compute slices and a number of memory slices, where each compute slice is a disjoint subset of the GPU's total compute resources and each memory slice is a disjoint subset of the GPU's total memory resources. The specific number of compute slices and memory slices will vary depending on the GPU model. For example, the A100 GPU mentioned earlier is composed of seven compute slices (each comprising 1/7 of its 6192 processing cores) and eight memory slices (each comprising ⅛ of its 40 GB of VRAM). These slices can be combined in various permutations in the form of MIG profiles, which are policies that a MIG-enabled client can select to define its GPU compute and memory requirements.

For instance, the table below depicts an example list of MIG profiles available for the A100 GPU:

TABLE 1

| | | | Number of |
|---|---|---|---|
| Profile | Number of | Number of | Instances |
| Name | Compute Slices | Memory Slices | Available |
| MIG 1g.5gb | 1 (out of 7 total) | 1 (out of 8 total) | 7 |
| MIG 2g.10gb | 2 (out of 7 total) | 2 (out of 8 total) | 3 |
| MIG 3g.20gb | 3 (out of 7 total) | 4 (out of 8 total) | 2 |
| MIG 4g.20gb | 4 (out of 7 total) | 4 (out of 8 total) | 1 |
| MIG 7g.40gb | 7 (out of 7 total) | 8 (out of 8 total) | 1 |

The first column of this table indicates the name of each profile, such as “MIG 1 g.5 gb,” “MIG 2 g.10 gb.” and so on. The second and third columns indicate the number of compute slices and memory slices included in the profile respectively. For example, the “MIG 2 g.10 gb” profile includes two compute slices and two memory slices. The last column of the table indicates the number of MIG instances corresponding to the profile that may be concurrently placed on the GPU. For example, three MIG instances corresponding to the “MIG 2 g.10 gb” profile may be concurrently placed on the A100 GPU because this GPU has a total of seven compute slices and eight memory slices.

At the time of provisioning a VM in host cluster 104, the creator/user of the VM can submit a provisioning request to VIM server 102 with a selection of a MIG profile that is appropriate for the VM's GPU workload, or in other words a MIG profile that specifies a sufficient number of compute and memory slices to meet the VM's requirements. Such a VM is referred to as a MIG-enabled VM. In response, VIM server 102 will place the VM on a GPU in host cluster 104 that has the number of compute and memory slices specified in the selected MIG profile free/unallocated, assuming such a GPU is available.

As noted in the Background section, one challenge with placing a large number of VMS on GPUs under the MIG model is that there is currently no automated technique for performing such placement in an optimal manner (i.e., a manner that minimizes the number of GPUs used). There are a number of existing techniques for optimally placing VMs on GPUs in the context of virtual GPU sharing, but virtual GPU sharing does not allow separate compute slices to be assigned to different clients; instead, it provides each client access to the entirety of a GPU's compute resources using a time-division multiplexing approach. Accordingly, these existing techniques cannot be applied as-is to the MIG context.

To address this deficiency, embodiments of the present disclosure provide a novel MIG-aware placement algorithm, shown via reference numeral 114 in FIG. 1, that can be implemented by VIM server 102 for optimally placing MIG-enabled VMs on the GPUs of host cluster 104. As mentioned above, an optimal placement is one that minimizes the number of GPUs used, or in other words packs the VMs into as few GPUs as possible. This reduces fragmentation of GPU resources and makes it easier to accommodate future VM provisioning requests.

At a high level, algorithm 114 involves formulating the placement optimization problem as an integer linear programming (ILP) problem. For example, given M VMs to be placed (each associated with a MIG profile specifying a number of compute slices and a number of memory slices requested by the VM) and N GPUs that can serve as placement targets, algorithm 114 can define an ILP problem that includes:
1. A set of coefficients corresponding to the compute slices and memory slices requested by each VM i for i=1, . . . , M;
2. a set of decision variables that indicate, among other things, whether a given VM i is placed on a given GPU j for j=1, . . . , N per the problem solution;
3. a set of constraints that ensures, among other things, that (a) each (placed) VM i is placed on a single GPU j with sufficient compute and memory resources to satisfy the VM's requested requirements, (b) the total allocated compute and memory resources on each GPU j do not exceed its maximum capacity, and (c) each VM i is placed on at most one GPU j; and
4. an objective function corresponding to the total number of GPUs used.

With these problem components in place, VIM server 102 can solve the ILP problem using an ILP solver, or in other words compute a solution for the decision variables that minimizes the objective function while satisfying the constraints. VIM server 102 can then place the VMs on the GPUs in accordance with the computed solution, thereby completing the placement process.

The remainder of this disclosure describes the operation of MIG-aware placement algorithm 114 in greater detail. It should be appreciated that FIG. 1 and the foregoing high-level description are illustrative and not intended to limit embodiments of the present disclosure. For example, although the foregoing description focuses on the placement of MIG-enabled VMs on GPUs, algorithm 114 may also be used to optimally place other types of MIG-enabled clients such as containers. Further, although FIG. 1 depicts a particular arrangement of entities within environment 100, other arrangements are possible (e.g., the functionality attributed to a particular entity may be split into multiple entities, entities may be combined, etc.). One of ordinary skill in the art will recognize other variations, modifications, and alternatives.

### 2. MIG-Aware Placement Algorithm and ILP Formulation

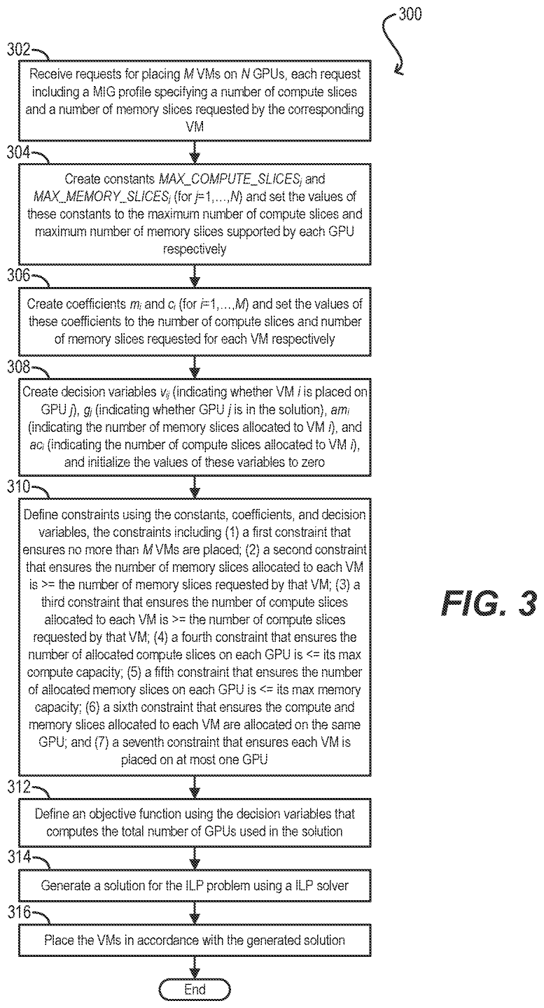

FIG. 3 depicts a flowchart 300 that provides additional details regarding the processing that may be performed by VIM server 102 for optimally placing a set of M MIG-enabled VMs on a set of N GPUs using MIG-aware placement algorithm 114 of FIG. 1 according to certain embodiments.

Starting with step 302, VIM server 102 can receive requests for placing the M VMs on the N GPUs, where each request includes a MIG profile specifying the number of compute slices and the number of memory slices requested by the corresponding VM. For example, a first request for a first VM may include a MIG profile that specifies two compute slices and two memory slices, a second request for a second VM may include a MIG profile that specifies three compute slices and two memory slices, and so on. It is assumed that each of these requests are fractional requests, or in other words includes a MIG profile that specifies a fraction of the total compute and memory slices of a given GPU. This is because a non-fractional request can be fulfilled by simply placing the VM corresponding to that request on the entirety of a single GPU.

Upon receiving these requests, VIM server 102 can proceed with formulating an ILP problem for computing an optimal placement of the M VMs on the N GPUs. For example, at step 304, VIM server 102 can create a set of constants MAX_COMPUTE_SLICESⱼ and MAX_MEM_SLICESⱼ (for j=1, . . . , N) and set the values of these constraints to the maximum number of compute slices and maximum number of memory slices supported by each GPU j respectively. In the scenario where all N GPUs are identical (i.e., are the same model), VIM server 102 can instead create/set a single MAX_COMPUTE_SLICES constant and a single MAX_MEM_SLICES constant that applies to all of the GPUs.

At step 306, VIM server 102 can create a set of coefficients m; and ci (for i=1, . . . , M) and set the values of these coefficients to the number of compute slices and number of memory slices requested by each VM i respectively, per the requests received at 302. This can involve, e.g., extracting the MIG profile included in each request and determining the number of compute slices and the number of memory slices specified by that profile.

At step 308, VIM server 102 can create a set of decision variables including vᵢⱼ (for i=1, . . . , M and j=1, . . . , N), gⱼ (for j=1, . . . , N), acᵢ (for=1, . . . , M), and amᵢ (for=1, . . . , M), and can initialize these variables to zero. vᵢⱼ is a binary variable that indicates whether VM i is placed on GPU j (value 1) or not (value 0). g; is a binary variable that indicates whether GPU j is used in the solution per variables vᵢⱼ (value 1) or not (value 0). acᵢ is an integer variable that indicates the number of compute slices allocated to VM i. And am; is an integer variable that indicates the number of memory slices allocated to VM i.

At step 310, VIM server 102 can define a set of constraints using the constants, coefficients, and decision variables created at 304-308 that ensures the correctness of the solution. In one set of embodiments, these constraints can include the following:
1. Σᵢ₌₁Σⱼ₌₁^{N}vᵢⱼ≤M: ensures that no more than M VMs are placed.
2. amᵢ≥mᵢ for i=1, . . . , M: ensures that the number of memory slices allocated to each VM is greater than or equal to the number of memory slices requested by that VM.
3. acᵢ≥cᵢ for i=1, . . . , M: ensures that the number of compute slices allocated to each VM is greater than or equal to the number of compute slices requested by that VM.
4. Σᵢ₌₁^{M}vᵢⱼ*acᵢ≤MAX_COMPUTE_SLICESⱼ for j=1, . . . , N: ensures that the number of allocated compute slices on each GPU is less than or equal to its max compute capacity.
5. Σᵢ₌₁^{M}vᵢⱼ*acᵢ≤MAX_MEM_SLICES; for j=1, . . . , N: ensures that the number of allocated memory slices on each GPU is less than or equal to its max memory capacity.
6. Σⱼ₌₁^{N}vᵢⱼ*amᵢ && vᵢⱼ*acᵢ==1 for i=1, . . . , M: ensures that the compute and memory slices allocated to each VM are allocated on the same GPU.
7. Σⱼ₌₁^{N}vᵢⱼ≤1 for i=1, . . . , M: ensures each VM is placed on at most one GPU.

At step 312, VIM server 102 can define an objective function using the decision variables created at 308 that computes the total number of GPUs used in the solution (i.e., the number of GPUs that have at least one VM placed on it). In a particular embodiment, this objective function can be defined as Σᵢ₌₁^{M}Σⱼ₌₁^{N}gⱼ*vᵢⱼ.

Once the foregoing problem components are created/defined, VIM server 102 can generate a solution to the ILP problem using any ILP solver known in the art (e.g., Gurobi optimizer, etc.) (step 314). This solution will include values for the decision variables that minimize the objective function while satisfying the constraints, thereby resulting in an optimal placement of the M VMs on the N GPUs.

Finally, at step 316, VIM server 102 can proceed with placing the VMs in accordance with the solution generated at 314. This process can include, e.g., creating or updating metadata associated with each VM to indicate the GPU on which it is placed and the VM's MIG profile. With this metadata in place, upon being powered on, the VM will be able to access a MIG instance of the GPU with the resources specified in its MIG profile.

It should be noted that FIG. 3 assumes all N GPUs are “empty” at the start of the algorithm, or in other words there are no VMs placed on them. However, there may be cases where VIM server 102 runs algorithm 114 a first time for M VMs (resulting in a first placement of those M VMs on the N GPUs), and then needs to run the algorithm a second time to place an additional L VMs on the same N GPUs.

In these types of scenarios, for the second run of the algorithm, VIM server 102 can formulate the ILP problem as comprising M+L VMs, pre-populate the decision variables to reflect the existing placements of the first M VMs (as computed via the first run), and then generate a solution to the ILP problem. This will result in optimal placements for the new L VMs, given the existing placements.

Certain embodiments described herein can employ various computer-implemented operations involving data stored in computer systems. For example, these operations can require physical manipulation of physical quantities-usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
receiving, by a computer system, a plurality of requests for placing a plurality of clients on a plurality of graphics processing units (GPUs), each request including a profile specifying a number of GPU compute slices and a number of GPU memory slices requested by a corresponding client;
determining, by the computer system, an optimal placement of the plurality of clients on the plurality of GPUs, the determining comprising:
formulating an integer linear programming (ILP) problem that includes:
a set of constants corresponding to a maximum number of GPU compute slices and a maximum number of GPU memory slices supported by each GPU;
a set of coefficients corresponding to the number of GPU compute slices and the number of GPU memory slices requested by each client;
a set of decision variables indicating whether a given client is placed on a given GPU;
a set of constraints that is based on the set of constants, the set of coefficients, and the set of decision variables; and
an objective function that is based on the set of decision variables and computes a total number of GPUs used; and
generating a solution for the ILP problem using an ILP solver, the solution including values for the decision variables that minimize the objective function while satisfying the set of constraints; and
placing, by the computer system, the plurality of clients on the plurality of GPUs in accordance with the solution.

2. The method of claim 1 wherein the computer system is a virtual infrastructure management (VIM) server, wherein the plurality of clients are virtual machines (VMs), and wherein the plurality of GPUs reside in a host cluster managed by the VIM server.

3. The method of claim 1 wherein the profile is a multi-instance GPU (MIG) profile and wherein the plurality of GPUs support MIG.

4. The method of claim 1 wherein the set of constraints includes:
a first constraint that ensures a number of GPU memory slices allocated to each client is greater than or equal to the number of GPU memory slices requested by the client; and
a second constraint that ensures a number of GPU compute slices allocated to each client is greater than or equal to the number of GPU compute slices requested by the client.

5. The method of claim 1 wherein the set of constraints includes:
a first constraint that ensures a total number of GPU memory slices allocated on each GPU is less than or equal to the maximum number of GPU memory slices supported by the GPU; and
a second constraint that ensures a total number of GPU compute slices allocated on each GPU is less than or equal to the maximum number of GPU compute slices supported by the GPU.

6. The method of claim 1 wherein the set of constraints includes a constraint that ensures all GPU compute and memory slices allocated to each client are allocated on a single GPU.

7. The method of claim 1 wherein the set of constraints includes a constraint that ensures each client is placed on at most one GPU.

8. A non-transitory computer readable storage medium having stored thereon program code executable by a computer system, the program code causing the computer system to execute a method comprising:
receiving a plurality of requests for placing a plurality of clients on a plurality of graphics processing units (GPUs), each request including a profile specifying a number of GPU compute slices and a number of GPU memory slices requested by a corresponding client;
determining an optimal placement of the plurality of clients on the plurality of GPUs, the determining comprising:
formulating an integer linear programming (ILP) problem that includes:
a set of constants corresponding to a maximum number of GPU compute slices and a maximum number of GPU memory slices supported by each GPU;
a set of coefficients corresponding to the number of GPU compute slices and the number of GPU memory slices requested by each client;
a set of decision variables indicating whether a given client is placed on a given GPU;
a set of constraints that is based on the set of constants, the set of coefficients, and the set of decision variables; and
an objective function that is based on the set of decision variables and computes a total number of GPUs used; and
generating a solution for the ILP problem using an ILP solver, the solution including values for the decision variables that minimize the objective function while satisfying the set of constraints; and
placing the plurality of clients on the plurality of GPUs in accordance with the solution.

9. The non-transitory computer readable storage medium of claim 8 wherein the computer system is a virtual infrastructure management (VIM) server, wherein the plurality of clients are virtual machines (VMs), and wherein the plurality of GPUs reside in a host cluster managed by the VIM server.

10. The non-transitory computer readable storage medium of claim 8 wherein the profile is a multi-instance GPU (MIG) profile and wherein the plurality of GPUs support MIG.

11. The non-transitory computer readable storage medium of claim 8 wherein the set of constraints includes:
a first constraint that ensures a number of GPU memory slices allocated to each client is greater than or equal to the number of GPU memory slices requested by the client; and
a second constraint that ensures a number of GPU compute slices allocated to each client is greater than or equal to the number of GPU compute slices requested by the client.

12. The non-transitory computer readable storage medium of claim 8 wherein the set of constraints includes:
a first constraint that ensures a total number of GPU memory slices allocated on each GPU is less than or equal to the maximum number of GPU memory slices supported by the GPU; and
a second constraint that ensures a total number of GPU compute slices allocated on each GPU is less than or equal to the maximum number of GPU compute slices supported by the GPU.

13. The non-transitory computer readable storage medium of claim 8 wherein the set of constraints includes a constraint that ensures all GPU compute and memory slices allocated to each client are allocated on a single GPU.

14. The non-transitory computer readable storage medium of claim 8 wherein the set of constraints includes a constraint that ensures each client is placed on at most one GPU.

15. A computer system comprising:
a processor; and
a non-transitory computer readable medium having stored thereon program code that, when executed, causes the processor to:
receive a plurality of requests for placing a plurality of clients on a plurality of graphics processing units (GPUs), each request including a profile specifying a number of GPU compute slices and a number of GPU memory slices requested by a corresponding client;
determine an optimal placement of the plurality of clients on the plurality of GPUS, the determining comprising:
formulating an integer linear programming (ILP) problem that includes:
a set of constants corresponding to a maximum number of GPU compute slices and a maximum number of GPU memory slices supported by each GPU;
a set of coefficients corresponding to the number of GPU compute slices and the number of GPU memory slices requested by each client;
a set of decision variables indicating whether a given client is placed on a given GPU;
a set of constraints that is based on the set of constants, the set of coefficients, and the set of decision variables; and
an objective function that is based on the set of decision variables and computes a total number of GPUs used; and
generating a solution for the ILP problem using an ILP solver, the solution including values for the decision variables that minimize the objective function while satisfying the set of constraints; and
place the plurality of clients on the plurality of GPUs in accordance with the solution.

16. The computer system of claim 15 wherein the computer system is a virtual infrastructure management (VIM) server, wherein the plurality of clients are virtual machines (VMs), and wherein the plurality of GPUs reside in a host cluster managed by the VIM server.

17. The computer system of claim 15 wherein the profile is a multi-instance GPU (MIG) profile and wherein the plurality of GPUs support MIG.

18. The computer system of claim 15 wherein the set of constraints includes:
a first constraint that ensures a number of GPU memory slices allocated to each client is greater than or equal to the number of GPU memory slices requested by the client; and
a second constraint that ensures a number of GPU compute slices allocated to each client is greater than or equal to the number of GPU compute slices requested by the client.

19. The computer system of claim 15 wherein the set of constraints includes:
a first constraint that ensures a total number of GPU memory slices allocated on each GPU is less than or equal to the maximum number of GPU memory slices supported by the GPU; and
a second constraint that ensures a total number of GPU compute slices allocated on each GPU is less than or equal to the maximum number of GPU compute slices supported by the GPU.

20. The computer system of claim 15 wherein the set of constraints includes a constraint that ensures all GPU compute and memory slices allocated to each client are allocated on a single GPU.

21. The computer system of claim 15 wherein the set of constraints includes a constraint that ensures each client is placed on at most one GPU.
